(19) United States
(12) Patent Application Publication
(10) Pub. No.: US 2014/0118497 A1
(43) Pub. Date: May 1, 2014

(54) IMAGE SENSING APPARATUS FOR SENSING DEPTH IMAGE

(71) Applicant: SAMSUNG ELECTRONICS CO., LTD., Suwon-si (KR)

(72) Inventors: Seong-Jin KIM, Seoul (KR); Albert Theuwissen, Bree (BE)

(73) Assignee: Samsung Electronics Co., LTD., Suwon-si (KR)

(21) Appl. No.: 13/849,699

(22) Filed: Mar. 25, 2013

(30) Foreign Application Priority Data
Oct. 30, 2012 (KR) 10-2012-0121248

(51) Int. Cl. H04N 13/02

(52) U.S. Cl. CPC H04N 13/0271
USPC 348/46

(57) ABSTRACT

Provided is an image sensing apparatus for obtaining a depth image. The image sensing apparatus may improve accuracy of the depth image by placing transmission gates and floating diffusion nodes of sub-pixels in a cross arrangement per pixel or row. The image sensing apparatus may represent the depth pixels of the depth image by controlling the binning of sensing signals output from the sub-pixels to place the depth pixels in a cross arrangement.

### CROSS-REFERENCE TO RELATED APPLICATION

This application claims the priority benefit of Korean Patent Application No. 10-2012-0121248, filed on Oct. 30, 2012, in the Korean Intellectual Property Office, the disclosure of which is incorporated herein by reference.

### BACKGROUND

1. Field

Example embodiments of the following disclosure relate to an image sensing apparatus, and more particularly, to an image sensing apparatus for improving accuracy and resolution of a depth image.

2. Description of the Related Art

A depth image refers to an image obtained by measuring a distance between an object and a sensor. The depth image may be obtained by various methods. Among them, a Time-of-Flight (ToF) technology may measure a time that light takes to return after reflecting off the object, to obtain a depth image in real time in which all the pixels have depth values.

The ToF may be measured using two methods, direct ToF and indirect ToF. Direct ToF may measure a time difference between a point in time in which light is irradiated onto an object and a point in time in which light reflects off the object and travels back to a sensor. Since direct ToF needs to sense a signal when light is incident, direct ToF requires a high-sensitivity device in a pixel. The high-sensitivity device may include, for example, a single-photon-avalanche-diode (SPAD). Also, direct ToF requires a time-to-digital converter to obtain a precise measurement of a very short time interval of several nanoseconds (ns).

Indirect ToF may measure a phase difference between a radiated light and a reflected light by modulating the radiated light at a predetermined frequency and demodulating the reflected light input in a pixel. Indirect ToF needs a modulatable pixel and synchronization between a pixel and a light source from which the radiated light is output. Generally, use of indirect ToF is more prevalent than use of direct ToF.

The indirect ToF needs at least two internal shutters to demodulate the modulated radiated light. The internal shutter may be used to transfer electrons generated by a photo-detector to a floating diffusion node through a transfer gate of polysilicon. For each pixel, at least two transfer gates and at least two floating diffusion nodes may be provided.

To obtain an accurate depth image, the transfer gates and the floating diffusion nodes located at the both sides of the photo-detector need to have the same characteristics. However, due to procedural reasons, it is difficult to manufacture the transfer gates and the floating diffusion nodes to be perfectly identical. In particular, asymmetry may occur due to different electron transfer directions and different sizes of the floating diffusion nodes at the both sides, resulting in reduced accuracy of the depth image.

In addition, a low spatial resolution of a ToF sensor may be another challenging issue. Current commercial sensors have a pixel size of 30 to 40 micrometers (μm) and resolution of Quarter Common Intermediate Format (QCIF) 176×144. To improve the spatial resolution, the pixel size needs to be reduced. However, as the pixel size becomes smaller, sensitivity of the sensor may be reduced and an error in the depth image may be increased. As a result, a depth error in the pixel may be increased.

Accordingly, there is a demand for development of a pixel architecture for improving a spatial resolution absent a change in pixel size.

### SUMMARY

The foregoing and/or other aspects are achieved by providing an image sensing apparatus for obtaining a depth image, the apparatus including a plurality of sub-pixels, and the depth image may include depth pixels represented by binning sensing signals output from the plurality of sub-pixels.

The image sensing apparatus may include the plurality of sub-pixels of an N×N grid.

For the plurality of sub-pixels, transmission gates and floating diffusion nodes may be placed in a line.

For the plurality of sub-pixels, transmission gates and floating diffusion nodes may be placed in a cross arrangement.

For the plurality of sub-pixels, the transmission gates and the floating diffusion nodes may be placed in a cross arrangement per pixel or row.

The image sensing apparatus may control the binning of the sensing signals output from the plurality of sub-pixels to place the depth pixels in a line.

The image sensing apparatus may control the binning of the sensing signals output from the plurality of sub-pixels to place the depth pixels in a cross arrangement in a horizontal direction.

The image sensing apparatus may control the binning of the sensing signals output from the plurality of sub-pixels to place the depth pixels in a cross arrangement in a vertical direction.

The image sensing apparatus may control the binning of the sensing signals output from the plurality of sub-pixels to place the depth pixels in a cross arrangement in a diagonal direction.

For each of the plurality of sub-pixels, transmission gates and floating diffusion nodes may be placed in a cross arrangement, and the image sensing apparatus may control the binning of the sensing signals output from the plurality of sub-pixels to place the depth pixels in a cross arrangement in a horizontal direction.

For each of the plurality of sub-pixels, transmission gates and floating diffusion nodes may be placed in a cross arrangement, and the image sensing apparatus may control the binning of the sensing signals output from the plurality of sub-pixels to place the depth pixels in a cross arrangement in a vertical direction.

For each of the plurality of sub-pixels, transmission gates and floating diffusion nodes may be placed in a cross arrangement, and the image sensing apparatus may control the binning of the sensing signals output from the plurality of sub-pixels to place the depth pixels in a cross arrangement in a diagonal direction.

The foregoing and/or other aspects are also achieved by providing an image sensing apparatus including a plurality of sub-pixels for which transmission gates and floating diffusion nodes may be placed in a combination of arrangements per pixel or row.

The foregoing and/or other aspects are also achieved by providing an image sensing apparatus that may represent depth pixels of the depth image by controlling the binning of sensing signals output from a plurality of sub-pixels based on resolution of the depth image.

The image sensing apparatus may control the binning of the sensing signals output from the plurality of sub-pixels to place the depth pixels in a cross arrangement in a horizontal direction.

The image sensing apparatus may control the binning of the sensing signals output from the plurality of sub-pixels to place the depth pixels in a cross arrangement in a vertical direction.

The image sensing apparatus may control the binning of the sensing signals output from the plurality of sub-pixels to place the depth pixels in a cross arrangement in a diagonal direction.

The foregoing and/or other aspects are also achieved by providing an image sensing apparatus including a plurality of sub-pixels for which transmission gates and floating diffusion nodes may be placed in a combination of arrangements per pixel or row, and the image sensing apparatus may represent depth pixels of the depth image by controlling the binning of sensing signals output from a plurality of sub-pixels based on resolution of the depth image.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates a pixel architecture of a depth pixel according to an example embodiment;

FIG. 2 illustrates a pixel architecture of a depth pixel according to another example embodiment;

FIG. 3 illustrates an arrangement structure of depth pixels according to an example embodiment;

FIG. 4 illustrates an arrangement structure of depth pixels according to another example embodiment;

FIG. 5 illustrates an arrangement structure of depth pixels according to still another example embodiment; and

FIG. 6 illustrates a combination of the pixel architecture of FIG. 2 and the arrangement structure of FIG. 4.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

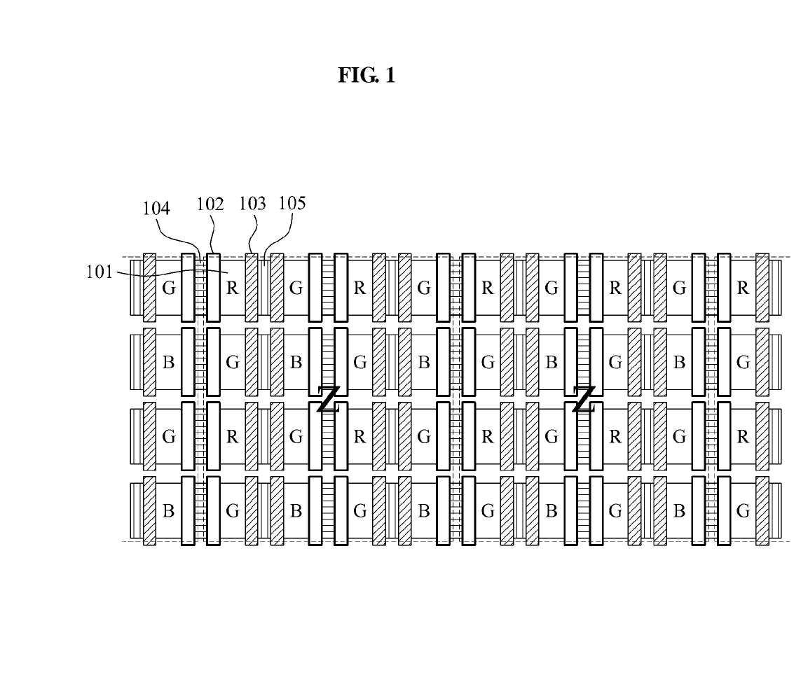

FIG. 1 illustrates a pixel architecture of a depth pixel according to an example embodiment.

Referring to FIG. 1, provided is a pixel architecture of a depth pixel represented by binning sensing signals output from a plurality of sub-pixels 101. A depth image may be represented through a plurality of depth pixels. In FIG. 1, the depth pixel may correspond to “Z”. Each sub-pixel 101 may correspond to one sub-pixel among a red sub-pixel R, a green sub-pixel G, and a blue sub-pixel B. An array of R, G, G, and B sub-pixels may form one pixel. The depth pixel may refer to (*a signal obtained by physically combining sensing signals output from the sub-pixels 101? a signal obtained by combining sensing signals output from the sub-pixels 101 in a form of hardware.

Hereinafter, the binning of the sensing signals output from the sub-pixels 101 is described in further detail.

When the sub-pixels 101 of, for example, a 4×4 grid is used, 4×1 binning may be performed on the sensing signals output from the sub-pixels 101, for example, in a array of R, G, R, and G sub-pixels or an array of G, B, G and B sub-pixels. Subsequently, four binning signals may be output and binned. Accordingly, a depth pixel may be represented.

Electrons generated in the sub-pixel 101 may be transferred to a floating diffusion node 1 FD1 104 through a transmission gate TG1 102 or a floating diffusion node 2 FD2 105 through a transmission gate TG2 103 iteratively at a predetermined cycle. The sub-pixels 101 arranged in a vertical direction may share the floating diffusion node 1 FD1 104 and the floating diffusion node 2 FD2 105, and the sub-pixels 101 arranged in a horizontal direction may share the transmission gate TG1 102 and the transmission gate TG2 103.

The transmission gate 1 TG1 102 and the transmission gate TG2 103 and the floating diffusion node 1 FD1 104 and the floating diffusion node 2 FD2 105 connected to the sub-pixel 101 may be placed in a line for each pixel or in each line. Within one depth pixel, a total of four floating diffusion nodes and transmission gates may be placed in a line.

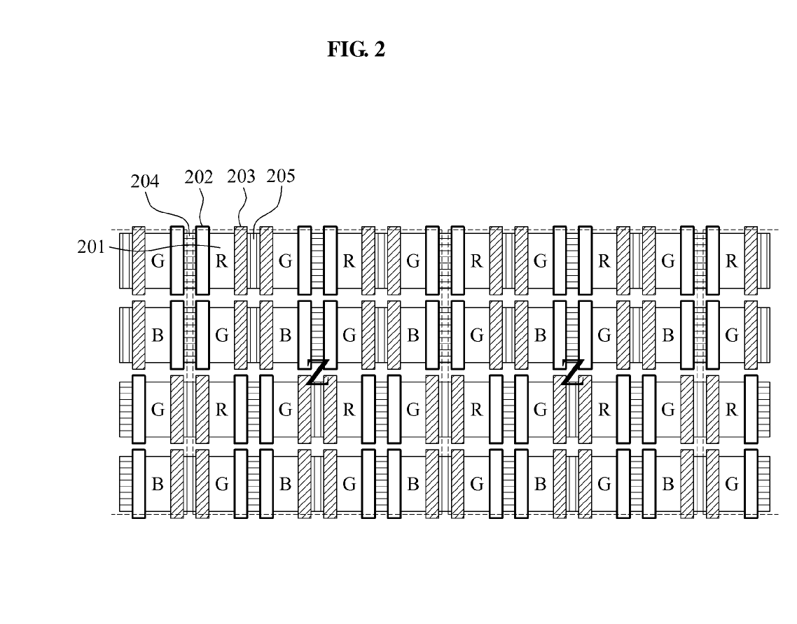

FIG. 2 illustrates a pixel architecture of a depth pixel according to another example embodiment.

According to another example embodiment, transmission gates 202 and 203 and floating diffusion nodes 204 and 205 connected to a sub-pixel 201 may be placed in a cross arrangement for each pixel or in each line.

Generally, it is difficult to manufacture the floating diffusion nodes 204 and 205 at the both sides of the sub-pixel 201 to be perfectly identical. The application of FIG. 1 may be available only when the floating diffusion nodes 204 and 205 located at the both sides of the sub-pixel 201 have similar characteristics. However, the application of FIG. 2 may be available although asymmetry occurs due to different characteristics of the floating diffusion nodes 204 and 205 at the both sides of the sub-pixel 201.

Referring to FIG. 2, for one depth pixel, the floating diffusion nodes 204 and 205 of the sub-pixel 201 in upper two lines and the floating diffusion nodes 204 and 205 of the sub-pixel 201 in lower two lines may be placed in a cross arrangement.

Within one depth pixel, the floating diffusion nodes 204 and 205 of the sub-pixel 201 may be placed in a cross arrangement for each pixel. Alternatively, within one depth pixel, the floating diffusion nodes 204 and 205 of the sub-pixel 201 may be placed in a cross arrangement in each line.

The foregoing disclosure may be also applied to the transmission gates 202 and 203. Accordingly, asymmetry caused by a difference between the floating diffusion nodes 204 and 205 may be minimized. As a result, accuracy of a depth image derived by binning a sensing signal output from the sub-pixel 201 may be improved.

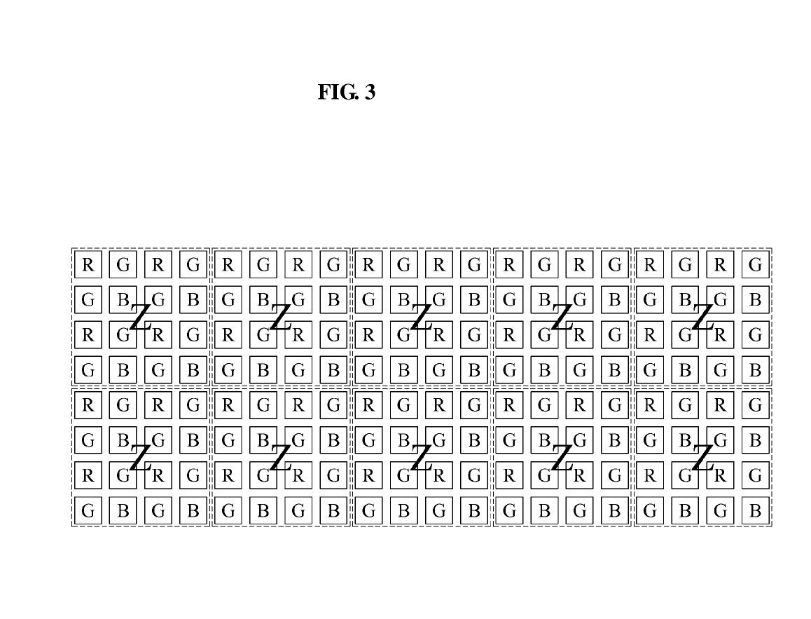

FIG. 3 illustrates an arrangement structure of depth pixels according to an example embodiment.

Referring to FIG. 3, one depth pixel Z may be represented by binning sensing signals output from sub-pixels of a 4×4 grid. Such depth pixels may be placed in a line.

The depth pixel Z represented through sub-pixels in an upper row and the depth pixel Z represented through sub-pixels in a lower row may be represented in a non-cross arrangement. The implementation of FIG. 3 may be completed by the image sensing apparatus controlling the sub-pixel binning. A depth image may be derived from the depth pixels represented by binning the sub-pixels.

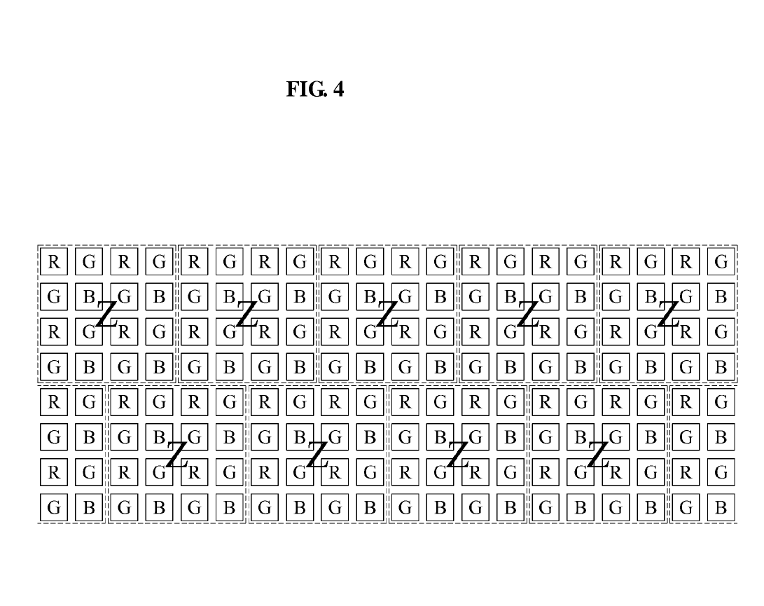

FIG. 4 illustrates an arrangement structure of depth pixels according to another example embodiment.

According to another example embodiment, depth pixels may be represented in a cross arrangement in a horizontal direction. When binning sub-pixels of a 4×4 grid, the image sensing apparatus may control the sub-pixel binning to shift the depth pixel represented through sub-pixels in an upper row by two sub-pixels in a horizontal direction with respect to the depth pixel represented through sub-pixels in a lower row.

In contrast, the image sensing apparatus may control the sub-pixel binning to shift the depth pixel represented through sub-pixels in a lower row by two sub-pixels in a horizontal direction with respect to the depth pixel represented through sub-pixels in an upper row. The extent of shift is not limited to the exemplary extent of FIG. 4, and may be determined differently according to example embodiments. The depth image of FIG. 4 may have higher vertical resolution than the depth image of FIG. 3.

Although not shown in FIG. 4, according to other example embodiments, depth pixels may be placed in a cross arrangement in a vertical direction. The foregoing disclosure may be applied to the controlling of the sub-pixel binning to place depth pixels in a cross arrangement in a vertical direction.

When binning sub-pixels of a 4×4 grid, the image sensing apparatus may control the sub-pixel binning to shift the depth pixel represented through sub-pixels in a left row by two sub-pixels in a vertical direction with respect to the depth pixel represented through sub-pixels in a right row.

In contrast, the image sensing apparatus may control the sub-pixel binning to shift the depth pixel represented through sub-pixels in a right row by two sub-pixels in a vertical direction with respect to the depth pixel represented through sub-pixels in a left row. The extent of such a shift is not limited to the exemplary extent of FIG. 4, and may be determined differently according to example embodiments.

Accordingly, a depth image may be output with improved horizontal or vertical resolution absent a change in sub-pixel structure by controlling the binning of sensing signals of sub-pixels to place depth pixels in a cross arrangement.

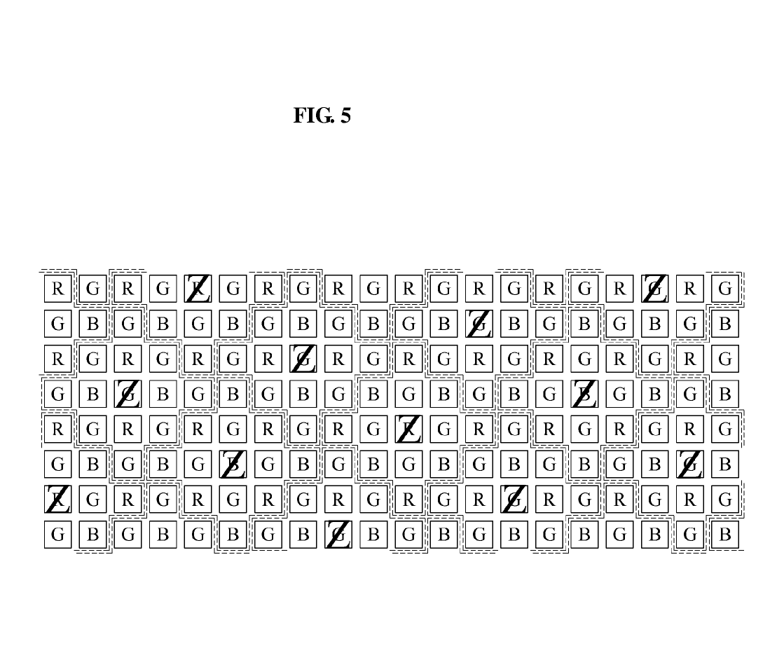

FIG. 5 illustrates an arrangement structure of depth pixels according to still another example embodiment.

According to still another example embodiment, depth pixels may be represented in a cross arrangement in a diagonal direction. The image sensing apparatus may control the sub-pixel binning to place depth pixels represented through the sub-pixels in a cross arrangement in a diagonal direction. A diagonal direction in a direction opposite to the exemplary diagonal direction of FIG. 5 may be given consideration.

The sub-pixel binning for representing the depth pixels in a cross arrangement in a diagonal direction may allow a depth image with higher horizontal and vertical resolutions than the depth image of FIG. 3.

Also, the resolution of the depth image may be improved by controlling a number of sub-pixels being binned to represent one depth pixel. As a number of sub-pixels being binned to represent a depth pixel is decreased, the resolution of the depth image may be increased.

In this example embodiment, pixel sensitivity may be reduced due to the same infrared (IR) transmittance required for color filters for red, green, and blue sub-pixels, and complex wiring for binning, however, the pixel sensitivity may be improved through an enhanced pixel process.

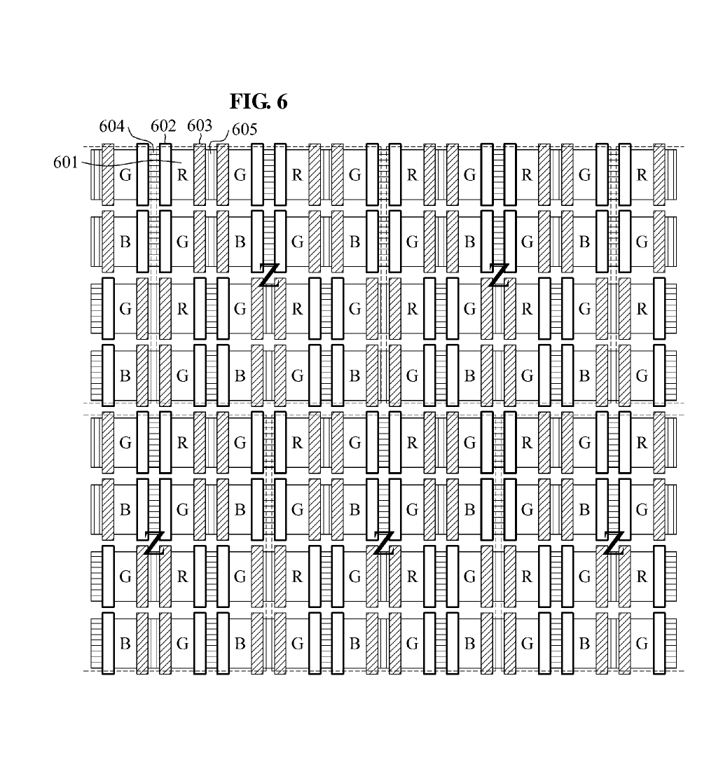

FIG. 6 illustrates a combination of the pixel architecture of FIG. 2 and the arrangement structure of FIG. 4.

The foregoing disclosure provides example embodiments for improving accuracy or resolution of a depth image, however, the example embodiment of FIG. 6 may achieve improvements in accuracy and resolution of a depth image.

For sub-pixels 601 of a 4×4 grid, transmission gates 602 and 603 and floating diffusion nodes 604 and 605 may be placed in a cross arrangement for each pixel or in each line. The sub-pixel binning may be controlled to place depth pixels Z represented through the sub-pixels 601 of a 4×4 grid in a cross arrangement in a horizontal direction.

Based on the same structure of the sub-pixels 601, the binning of sensing signals output from the sub-pixels 601 may be controlled to place the depth pixels Z represented through the sub-pixels 601 of a 4×4 grid in a cross arrangement in a vertical direction. Also, based on the same structure of the sub-pixels 601, the binning of sensing signals output from the sub-pixels 601 may be controlled to place the depth pixels Z represented through the sub-pixels 601 of a 4×4 grid in a cross in a diagonal direction.

According to an example embodiment, an image sensing apparatus may include a plurality of sub-pixels, and a depth image may include depth pixels represented by binning sensing signals output from the plurality of sub-pixels.

The image sensing apparatus may include the plurality of sub-pixels of an N×N grid.

For the plurality of sub-pixels, transmission gates and floating diffusion nodes may be placed in a line.

For the plurality of sub-pixels, transmission gates and floating diffusion nodes may be placed in a cross arrangement.

For the plurality of sub-pixels, the transmission gates and the floating diffusion nodes may be placed in a cross arrangement per pixel or row.

The image sensing apparatus may control the binning of the sensing signals output from the plurality of sub-pixels to place the depth pixels in a line.

The image sensing apparatus may control the binning of the sensing signals output from the plurality of sub-pixels to place the depth pixels in a cross arrangement in a horizontal direction.

The image sensing apparatus may control the binning of the sensing signals output from the plurality of sub-pixels to place the depth pixels in a cross arrangement in a vertical direction.

The image sensing apparatus may control the binning of the sensing signals output from the plurality of sub-pixels to place the depth pixels in a cross arrangement in a diagonal direction.

For each of the plurality of sub-pixels, transmission gates and floating diffusion nodes may be placed in a cross arrangement, and the image sensing apparatus may control the binning of the sensing signals output from the plurality of sub-pixels to place the depth pixels in a cross arrangement in a horizontal direction.

For each of the plurality of sub-pixels, transmission gates and floating diffusion nodes may be placed in a cross arrangement, and the image sensing apparatus may control the binning of the sensing signals output from the plurality of sub-pixels to place the depth pixels in a cross arrangement in a vertical direction.

For each of the plurality of sub-pixels, transmission gates and floating diffusion nodes may be placed in a cross arrangement, and the image sensing apparatus may control the binning of the sensing signals output from the plurality of sub-pixels to place the depth pixels in a cross arrangement in a diagonal direction.

According to another example embodiment, an image sensing apparatus may include a plurality of sub-pixels, for which transmission gates and floating diffusion nodes may be placed in a combination of arrangements per pixel or row.

According to still another example embodiment, an image sensing apparatus may represent depth pixels of the depth image by controlling the binning of sensing signals output from a plurality of sub-pixels based on resolution of the depth image.

The image sensing apparatus may control the binning of the sensing signals output from the plurality of sub-pixels to place the depth pixels in a cross arrangement in a horizontal direction.

The image sensing apparatus may control the binning of the sensing signals output from the plurality of sub-pixels to place the depth pixels in a cross arrangement in a vertical direction.

The image sensing apparatus may control the binning of the sensing signals output from the plurality of sub-pixels to place the depth pixels in a cross arrangement in a diagonal direction.

According to further another example embodiment, an image sensing apparatus may include a plurality of sub-pixels, for which transmission gates and floating diffusion nodes may be placed in a combination of arrangements per pixel or row, and may represent depth pixels of the depth image by controlling the binning of sensing signals output from a plurality of sub-pixels based on resolution of the depth image.

Accordingly, asymmetry may be minimized through arrangement of transmission gates and floating diffusion nodes in a proper combination of patterns for a plurality of sub-pixels that may be binned by the image sensing apparatus to represent one depth pixel. By minimizing the asymmetry, accuracy of a depth image output from the image processing apparatus may be improved.

Also, resolution of the depth image may be improved by placing sub-pixels to be binned at different locations. The image sensing apparatus may perform the sub-pixel binning to place the depth pixels in a cross arrangement in a horizontal, vertical, or diagonal direction, to improve the resolution of the depth image.

This sub-pixel structure may be applied to an image sensing apparatus for obtaining a depth image as well as an image sensing apparatus for obtaining a color image and a depth image.

The methods according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard discs, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

According to the example embodiments, transmission gates and floating diffusion nodes connected to sub-pixels may be placed in a cross arrangement to improve accuracy of a depth image.

According to the example embodiments, depth pixels represented through sub-pixels may be placed in a cross arrangement to improve resolution of a depth image.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image sensing apparatus for obtaining a depth image, the apparatus comprising:
a plurality of sub-pixels,
wherein the depth image includes depth pixels represented by binning sensing signals output from the plurality of sub-pixels.

2. The apparatus of claim 1, wherein the image sensing apparatus comprises the plurality of sub-pixels of an N×N grid.

3. The apparatus of claim 1, wherein transmission gates and floating diffusion nodes of the plurality of sub-pixels are placed in a line.

4. The apparatus of claim 1, wherein transmission gates and floating diffusion nodes of the plurality of sub-pixels are placed in a cross arrangement.

5. The apparatus of claim 4, wherein the transmission gates and the floating diffusion nodes of the plurality of sub-pixels are placed in a cross arrangement per pixel or row.

6. The apparatus of claim 1, wherein the image sensing apparatus controls the binning of the sensing signals output from the plurality of sub-pixels to place the depth pixels in a line.

7. The apparatus of claim 1, wherein the image sensing apparatus controls the binning of the sensing signals output from the plurality of sub-pixels to place the depth pixels in a cross arrangement in a horizontal direction.

8. The apparatus of claim 1, wherein the image sensing apparatus controls the binning of the sensing signals output from the plurality of sub-pixels to place the depth pixels in a cross arrangement in a vertical direction.

9. The apparatus of claim 1, wherein the image sensing apparatus controls the binning of the sensing signals output from the plurality of sub-pixels to place the depth pixels in a cross arrangement in a diagonal direction.

10. The apparatus of claim 1, wherein transmission gates and floating diffusion nodes of the plurality of sub-pixels are placed in a cross arrangement, and
the image sensing apparatus controls the binning of the sensing signals output from the plurality of sub-pixels to place the depth pixels in a cross arrangement in a horizontal direction.

11. The apparatus of claim 1, wherein transmission gates and floating diffusion nodes of the plurality of sub-pixels are placed in a cross arrangement, and
the image sensing apparatus controls the binning of the sensing signals output from the plurality of sub-pixels to place the depth pixels in a cross arrangement in a vertical direction.

12. The apparatus of claim 1, wherein transmission gates and floating diffusion nodes of the plurality of sub-pixels are placed in a cross arrangement, and
the image sensing apparatus controls the binning of the sensing signals output from the plurality of sub-pixels to place the depth pixels in a cross arrangement in a diagonal direction.

13. An image sensing apparatus for obtaining a depth image, the apparatus comprising:
a plurality of sub-pixels for which transmission gates and floating diffusion nodes are placed in a combination of arrangements per pixel or row.

14. An image sensing apparatus for obtaining a depth image, wherein the apparatus represents depth pixels of the depth image by controlling the binning of sensing signals output from a plurality of sub-pixels based on resolution of the depth image.

15. The apparatus of claim 14, wherein the image sensing apparatus controls the binning of the sensing signals output from the plurality of sub-pixels to place the depth pixels in a cross arrangement in a horizontal direction.

16. The apparatus of claim 14, wherein the image sensing apparatus controls the binning of the sensing signals output from the plurality of sub-pixels to place the depth pixels in a cross arrangement in a vertical direction.

17. The apparatus of claim 14, wherein the image sensing apparatus controls the binning of the sensing signals output from the plurality of sub-pixels to place the depth pixels in a cross arrangement in a diagonal direction.

18. An image sensing apparatus for obtaining a depth image, the apparatus comprising:
a plurality of sub-pixels for which transmission gates and floating diffusion nodes are placed in a combination of arrangements per pixel or row,
wherein the image sensing apparatus represents depth pixels of the depth image by controlling the binning of sensing signals output from a plurality of sub-pixels based on resolution of the depth image.
